(19) United States
(12) Patent Application Publication
(10) Pub. No.: US 2013/0230843 A1
(43) Pub. Date: Sep. 5, 2013

(54) INTERSCHOLASTIC, INTERDISCIPLINARY FORUM FOR USE BY STUDENTS AND INSTRUCTORS AT EDUCATION INSTITUTIONS

(71) Applicant: Sean T. CASEY, Cuba City, WI (US)

(72) Inventor: Sean T. CASEY, Cuba City, WI (US)

(21) Appl. No.: 13/777,257

(22) Filed: Feb. 26, 2013

Related U.S. Application Data
(60) Provisional application No. 61/606,097, filed on Mar. 2, 2012.

(51) Int. Cl. G09B 7/00

(52) U.S. Cl. CPC G09B 7/00
USPC 434/350

(57) ABSTRACT

A topic selection process is provided for classrooms which allows instructors from different institutions to suggest topics, pushing the entire list of topics back out to the instructors for selection, and then creating topic forums for the topics that more than one instructor selects.

### CROSS REFERENCE TO RELATED APPLICATION

This application claims the benefit of U.S. Provisional Patent Application No. 61/606,097 filed Mar. 2, 2012, the entire disclosure of which is incorporated by reference herein.

### BACKGROUND OF THE INVENTION

Many software platforms have been developed for allowing students to interact with instructions and with each other in electronic forums. Some of these platforms are solely used in a virtual classroom environment, whereas other platforms are used in conjunction with a traditional classroom experience. There are many functionalities that are not currently being provided by such platforms, some of which are described below.

The present invention is described in the context of a learning environment referred to as Symposium 360™.

### BRIEF DESCRIPTION OF THE DRAWINGS

For the purpose of illustrating the invention, there is shown in the drawings embodiments which are presently preferred. However, the invention is not limited to the precise arrangements and instrumentalities shown.

In the drawings:

FIG. 1 shows an overall block diagram of the users involved in the multidisciplinary online interactive forum system.

FIGS. 2a and 2b show a block diagram detailing the topic selection process that will be used to establish the topics that will be discussed amongst various instructors and students.

FIG. 3 shows an exemplary user interface display screen of the Topic Discussion Schedule.

FIG. 4 shows an exemplary user interface display screen of the registration page.

FIG. 5 shows an exemplary user interface display screen of the main page, distinguishing between the different types of forums; Specific Educational Forums vs. Open Topic Forums. The user control panel is also highlighted.

FIG. 6 shows an exemplary user interface display screen of the Specific Forum Main Page highlighting the Discussion Topic Schedule, as well as specific topics that are active.

FIG. 7 shows a flow diagram demonstrating the relationship between the users of the site, the various pages of the site, and how the users (or general observers) can interact with these aspects of the site.

FIG. 8 shows an exemplary user interface display screen of the discussions that an individual may have participated in during a given year.

FIGS. 9a and 9b, taken together, show an exemplary user interface display screen of the posting directions for both the 1^{st} and 2^{nd} posting period for each topic.

FIG. 10 shows an exemplary user interface display screen of the approval process for the responses submitted during the 1^{st} posting period.

FIG. 11 shows an exemplary user interface display screen of the poll one may see associated with a topic during the 1^{st} posting period.

FIG. 12 shows an exemplary user interface display screen of the results of a poll associated with a given discussion topic.

FIGS. 13a and 13b, taken together, show an exemplary user interface display screen of potential comments one may submit during the 1^{st} posting period.

FIG. 14 shows an exemplary user interface display screen of potential comments one may submit during the 2^{nd} posting period.

FIG. 15 shows an exemplary user interface display screen of the private message one may receive if another individual has directly quoted/responded to one of their comments in the forum.

FIG. 16 shows an exemplary user interface display screen of the private message one may receive if another individual has directly quoted/responded to one of their comments in the forum.

FIG. 17 shows a flow diagram depicting how certain discussions may get archived and reintroduced into the system. This occurs when instructors want their students to discuss topics currently on the site.

### DETAILED DESCRIPTION OF THE INVENTION

Certain terminology is used herein for convenience only and is not to be taken as a limitation on the present invention.

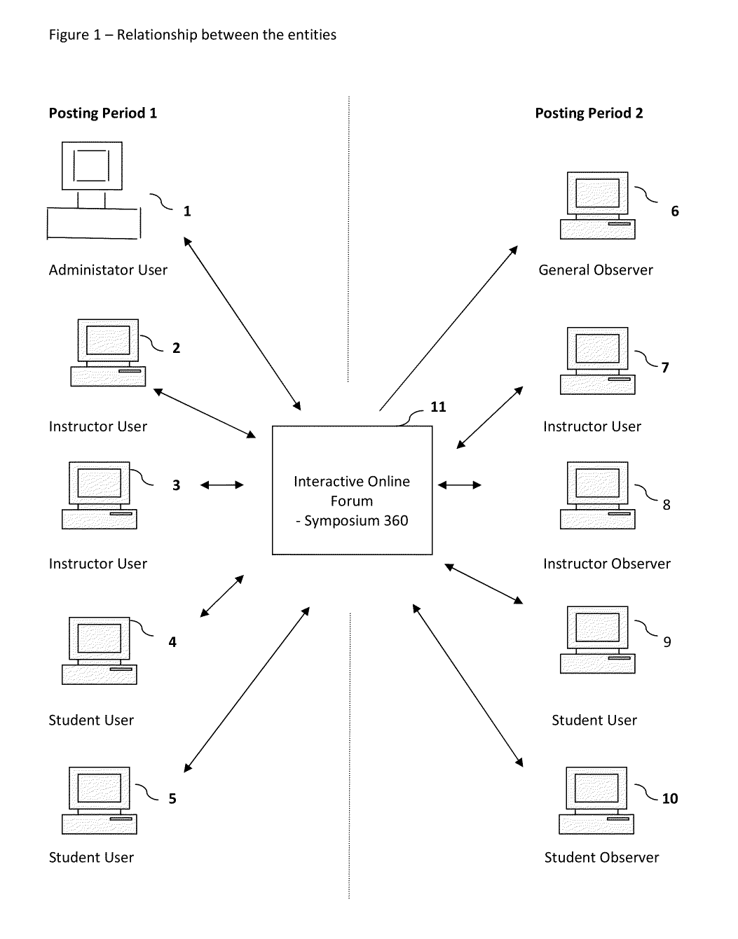

Referring to FIG. 1, the present invention consists of a multidisciplinary interactive online forum 11 specifically designed for instructors & students from different classrooms to discuss pertinent topics as agreed upon in advance by the participating parties. The forum can take place on various free forum software systems currently on the market today such as phpBB (PHP Bulletin Board). This interactive forum will be viewable to anyone in the general public who has access to the World Wide Web. However, only certain individuals will be able to actively participate in it. More specifically, the system consists of instructor users 2, 3, 7, who have selected specific topics that will be discussed by student users 4,5, 9. All of these individuals may or may not be from the same institution of learning. They have equal posting and access capabilities on the website. Also included in the system are instructor observers 8, who are part of the community but have not chosen to have their students participate in the discussion. These students are referred to as student observers 10. As will be described later, the student observers and instructor observers are unable to participate in posting responses during the 1st posting period; however, they will be able to participate in posting and viewing responses during the 2^{nd} posting period for each topic. Although not depicted in FIG. 1, 1, 2,3,4,5 can also post during the 2^{nd} posting period. The general observer 6, is an individual who is not affiliated with any institution and, as indicated by the 1-way arrow, can view, but not contribute any information or interact with anyone on the interactive forum. This will allow individuals in the general public to learn about the viewpoints/thoughts of highly educated people on a given topic. In addition, they cannot view the profiles of any registered users. This entire process will be organized and facilitated by Administrator User, 1.

In the context of the present invention, the word “institution” can represent any level of education (high school, college/university or professional organizations). The word “instructor” can represent both those who fill the traditional academic “teacher” role, as well as those who are simply the selected leader of their respective organization. The word “student” can represent both students still in academia as well as members of an organization. In addition, a student posting may represent that of 2-3+ individuals who are working together as a team in accordance to their instructors wishes.

### 1. Topic Selection Process

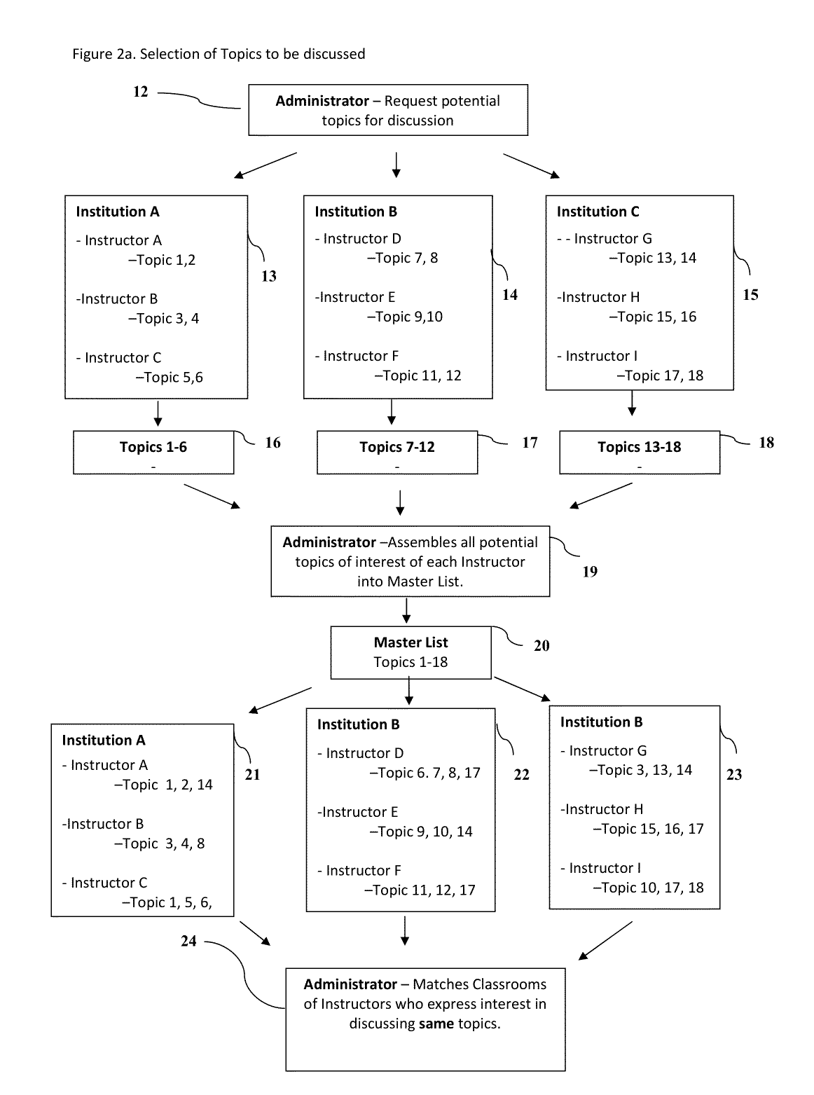

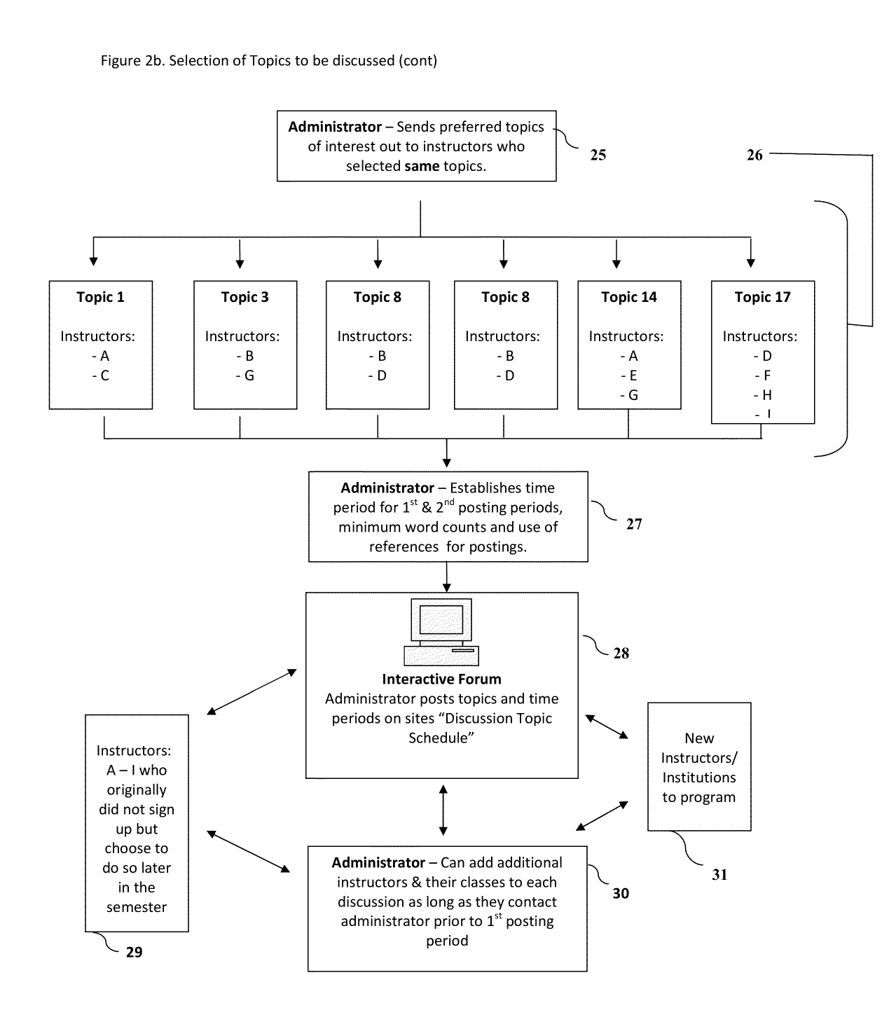

The selection of the topics that will be discussed on the forum is shown in FIG. 2a & FIG. 2b. The process is initiated by the administrator 12 who sends out a note to all instructors/institutions 13, 14, 15 that have expressed interest participating in interactive forum. These instructors can be teaching in different, yet still semi-related education disciplines at each institution such as Healthcare, Social Sciences, and the like. For instance, Instructor A may teach Nutritional Biochemistry 202 at Institution A (13), Instructor B may teach Exercise Physiology 202 at Institution A (13), Instructor E may teach Sports Nutrition 303 at Institution B (14) and instructor I may teach Topics in Health and Wellness at Institution C (15). Likewise the instructors may teach social science courses such as Economics 300, Religious Studies 300, Political Science 330, and similar. Each instructor writes down topics that they potentially would like to have their students discuss 16, 17, 18 and sends them back to the administrator. Each instructor can send their suggested topics into the administrator on their own. That is, if multiple instructors from the same institution are participating, they do not have to assemble their topics into one “institution” list before submitting them to the administrator. The administrator then proceeds to assemble all of the topics 19 onto one master list 20 which is then sent back out to all of the participating instructors and institutions. Upon receiving the master list, each instructor signs up for the specific topics that they would like their class to discuss with other classrooms 21, 22, 23. This may include topics they originally put forth as well as those suggested by other instructors 13, 14, 15. Their selections are then sent back to the administrator who identifies the instructors who express interest in discussing the same topics 24. The time period in which this activity occurs is referred to herein as the “initial sign up period.”

Upon identifying any topic in which two or more different instructors state that they would like to discuss, as depicted in FIG. 2b, the administrator notifies the participating parties and informs them which other instructors would like to discuss the topic. This interaction is shown in 25, 26. The administrator assists the instructors in setting up minimum word counts, use of references, as well as a time frame in which the topic will be discussed 27. This discussion can take place between classes at the same institutions as well as between classes at different institutions. In other words, one can have a topic discussion set up involving classes at different institutions such as Econ 101 at Institution A & Econ 101 at Institution B or involving only classes at the same institution such as Econ 101 at Institution A & Business Ethics 101 at Institution B.

Once the timeframes and minimum word counts for each discussion have been established, the administrator posts the topics, dates and participating parties in the “Discussion Topic Schedule” section of the interactive forum as depicted in step 28 of the selection process. This entire selection process 12-28 can take place prior to the start of each academic semester or on a quarterly basis.

The communications, topic selection process, and posting that occurs in the steps of FIGS. 2a and 2b all occur using a processor (not shown) executing in the forum 11 of FIG. 1.

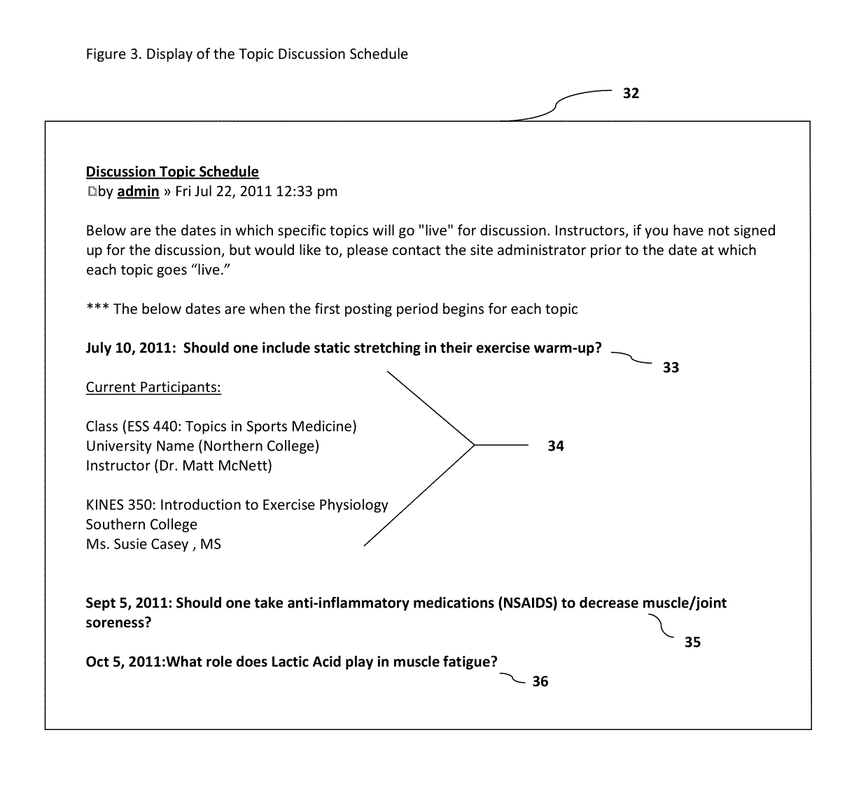

The dates at which each one of these discussions will take place will be posted in advance to when they will actually occur in the topic discussion schedule section of the site which can be accessed by clicking on the Discussion Topic Schedule Tab 48. A visual representation of the Discussion Topic Schedule can be seen in FIG. 3. Thus, as depicted in FIG. 2b, other instructors who originally didn't sign up for the topic during the initial sign up period can choose to opt in as long as they do so prior to the start of the first posting period. This interaction is shown in steps 28-30. In addition, new institutions/instructors 31 who join Symposium 360 mid-year or mid-quarter, and were not part of the original topic selection process, can register their students to participate in a discussion. This time period, between the initial sign up period and when the topic goes live is referred to herein as the “second sign up period.”

An example interface display screen for the Discussion Topic Schedule 32 can be found in FIG. 3. As shown in FIG. 3, each topic (33, 35, 36) listed will be that which has been agreed upon in advance by two or more instructors. Information 34 that will be included with each specific topic includes the classes, institutions and instructors who lead each particular class. Although not depicted in FIG. 3, the same information 34 (class, institution, instructor) listed for topic 33, would be listed for both 35, 36. Only the administrator user will be able to post information in this area.

The Discussion Topic Schedule Interface 32 will be working on a continuous basis. In other words, as soon as a new topic date is set, it will be added to the list. Likewise if an instructor/institution 29, 31 decides to join the discussion during the second sign up period, their information 34 will be added to the discussion topic schedule. Topics may be removed from the list after their start dates have passed.

### 2. Registration Process

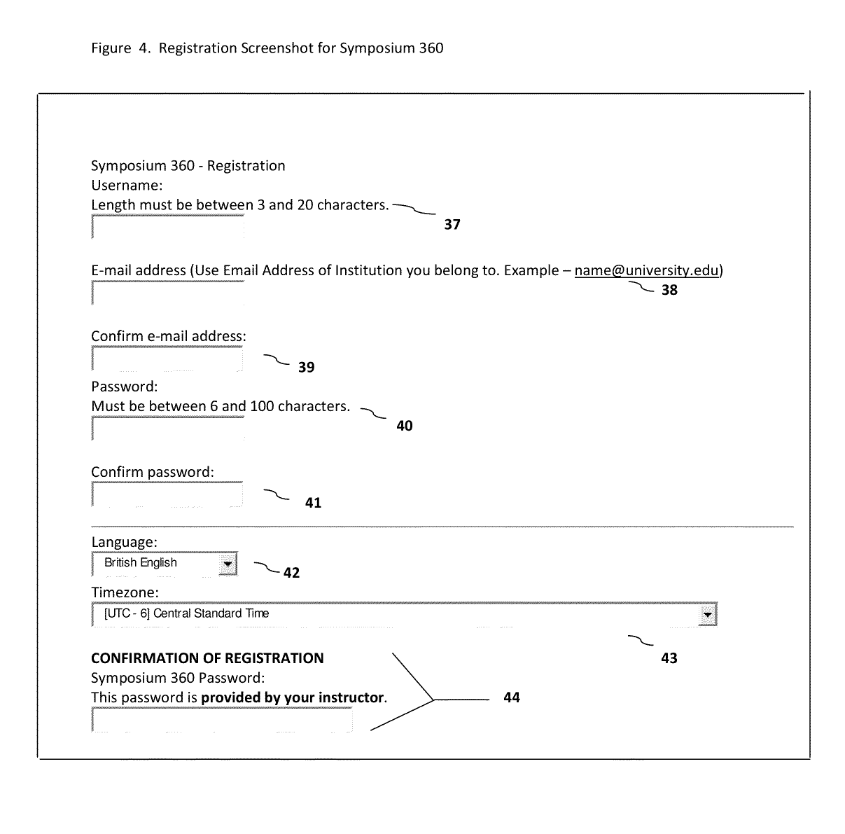

Upon signing their students up for discussion, all individuals (both students and instructors) will have to register with Symposium 360. This is displayed in FIG. 4. Required sign up fields include username 37, email address 38, 39 associated with institution one belongs to, personal password 40, 41, language 42, and time zone 43. In addition, they will need to type in a password, which will be referred to as the “confirmation password,” 44 that is given to them by their instructor. Built into this registration process are two key features that will serve to limit posting access in the forum. First, is the use of an institution email address 38, 39. This will be used to restrict access when posting to topics during the 1^{st} posting period, which will be discussed in greater detail later. Second, each participating instructor will be given a password 44 upon signing their class up for Symposium 360. Each one of their students must correctly type this password 44 into the system in order to participate in the interactive forum discussions. Thus, individuals who have no institution affiliations, such as general observers 6, will be prevented from contributing or interacting with anyone on the site. The confirmation password 44 differs from the personal password 40, 41 that they typed in as the confirmation password 44 will only be used once (when signing up), whereas the personal password 40, 41 will be used every time the individual “logs in” to the system.

### 3. Accessing Topic Posting Information

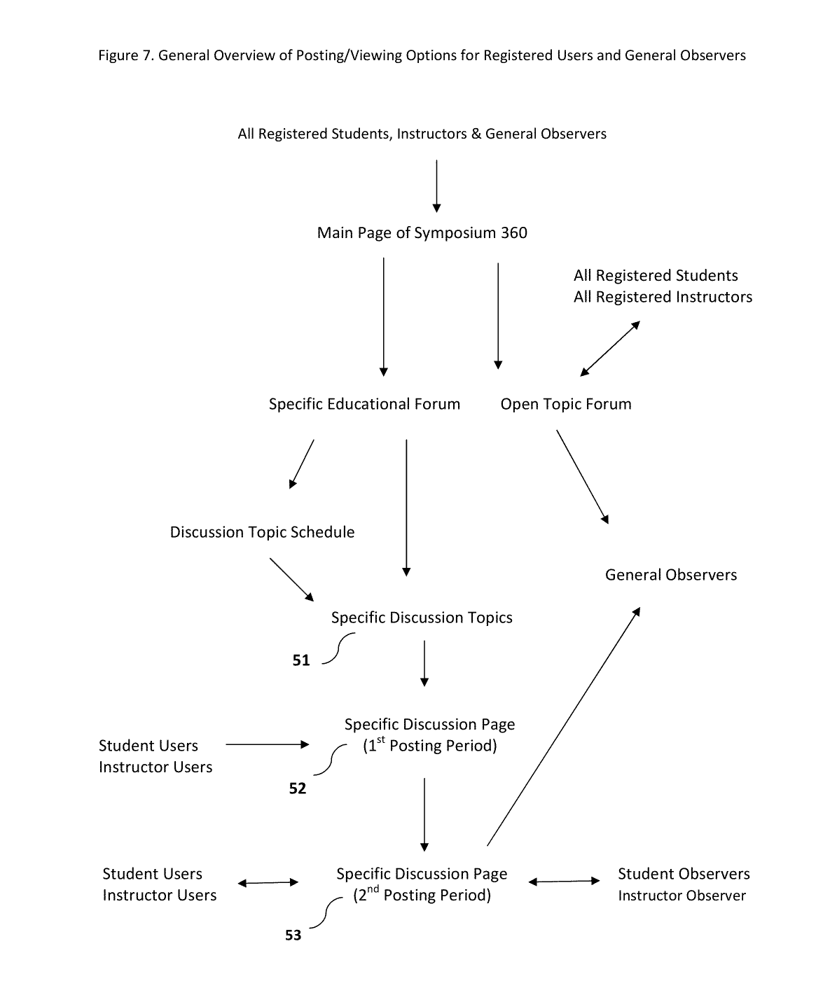

Upon registering for the system, students and instructors will be able to actively participate in the site. General observers will not be able to register with the site, thus limiting their ability to participate. A general overview of the interaction between individuals 2-10, the various forums and posting periods is depicted in FIG. 7. This entire process will be described in greater detail in the paragraphs that follow.

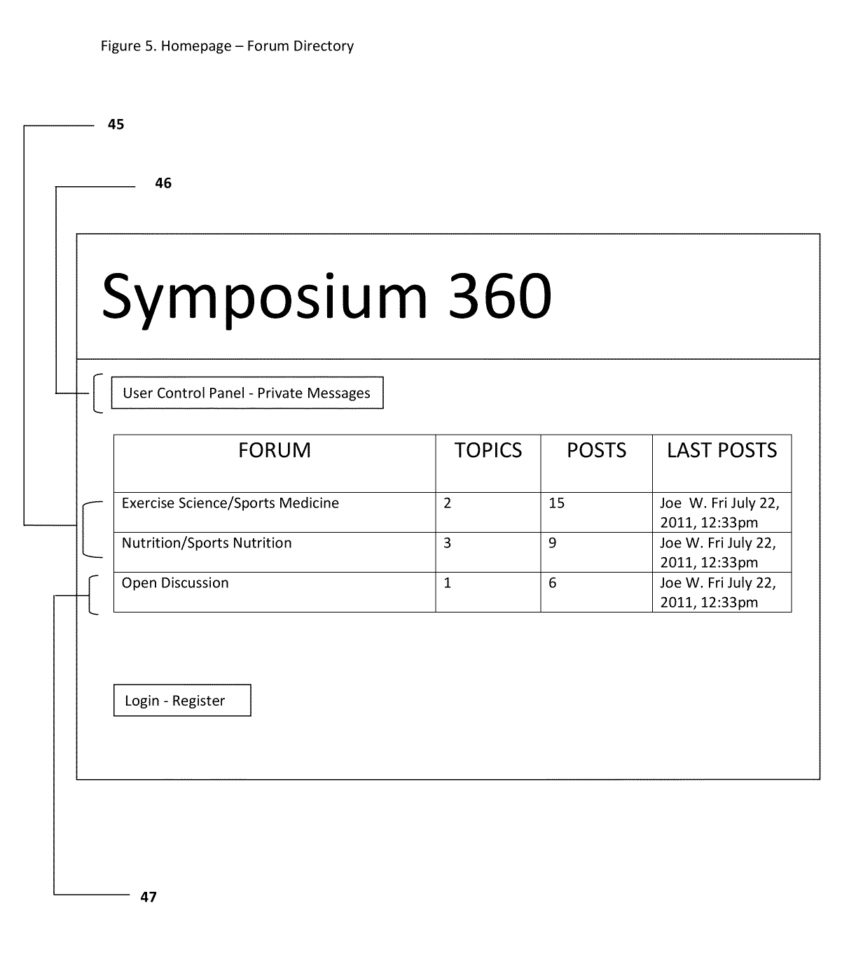

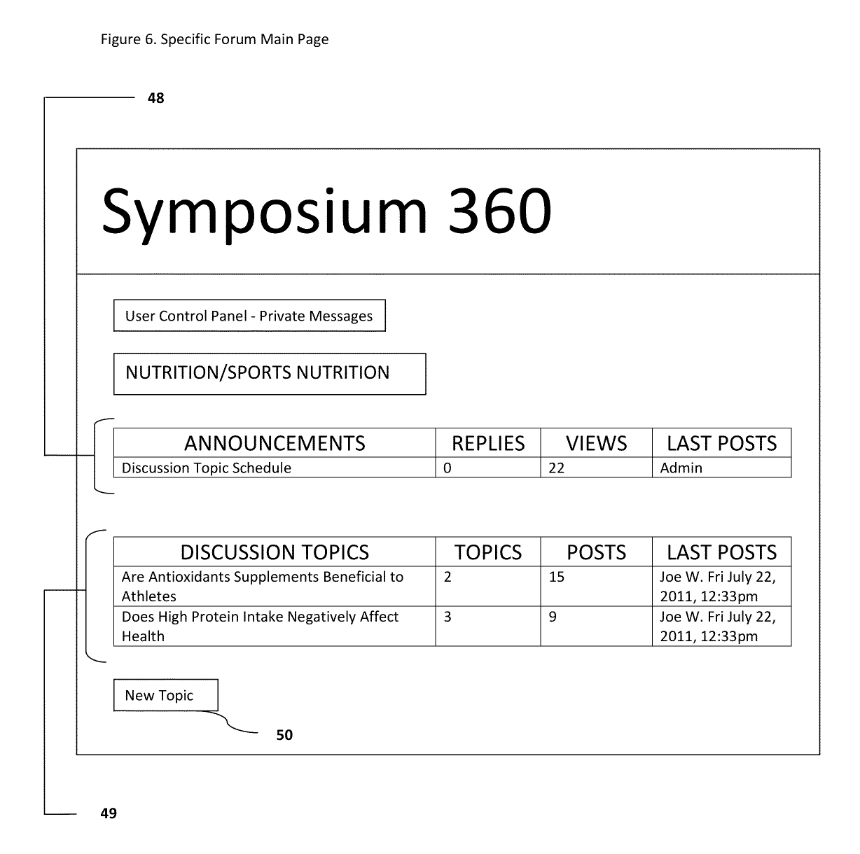

Upon logging into the site, one will come to a main page, such as shown in FIG. 5, which displays all of the forums included in the system, the education specific forums 45 and open forums 47. The specific forums 45 shown in FIG. 5 are merely examples of possible specific educational forums. These forums could also be dedicated to topics such as religious studies, agriculture, political science, and the like. In essence, any educational discipline could be included in the forum. Clicking on these specific education forums will take one to a page similar to that shown in FIG. 6 which displays the individual forum. In this particular forum, it is the Nutrition/Sports Nutrition forum. Included in this display is the Discussion Topic Schedule tab 48, which, upon clicking will take you to a screen similar to that shown in FIG. 3. Also present here are tabs for “live” topic discussions 49 that are in either their 1^{st} or 2^{nd} posting periods and will be referred to as “Specific Discussion Topics”. Clicking on the tabs for the Specific Discussion Topics will take you to the “Specific Discussion Page” which may be in either the 1^{st} or 2^{nd} posting periods. The relationship between the Specific Discussion Topics and Specific Discussion Pages is graphically represented in 51-53. Also included on specific educational forum pages are the New Topic display button 50 which can only be utilized by the Administrator User.

Referring back to the site's main page shown in FIG. 5, in addition to forums that are specifically dedicated to discussion of topics pre-selected by instructors with the assistance of the administrator user (outlined in steps 12-28), there will be an “Open Discussion Topic” forum 47 in which registered users will be able to freely discuss any topic they choose with other members of the site. This latter forum will function similar to most standard ones found on the internet today. More specifically, registered users 1-5, 7-10 (but not general observer 6) will be able to freely discuss topics of their choosing without any direct involvement of the administrator user. Although these topics are of their choosing, they must fall within the general breath of a given educational discipline. Clicking on the tab for this forum 47 will take you to a page similar to that shown in FIG. 6. However, on this page, registered users will be able to post new topics and freely post responses to each topic.

Also included in FIG. 5 is the user control panel and private message tabs 46. Clicking on these tabs will take individuals into the settings section of their personal account where they can control the information people can view about them, set emailing/messaging preferences with other registered users, subscribe to updates regarding a specific discussion that they are following/participating in and also be notified if someone has directly quoted one of their responses in the forums. The notification upon being directly quoted comes into play during the 2^{nd} posting period. In addition, they can make personal information about themselves available such as interest, occupations, and similar information. In providing this feature, users will be able to network with individuals who have common interest.

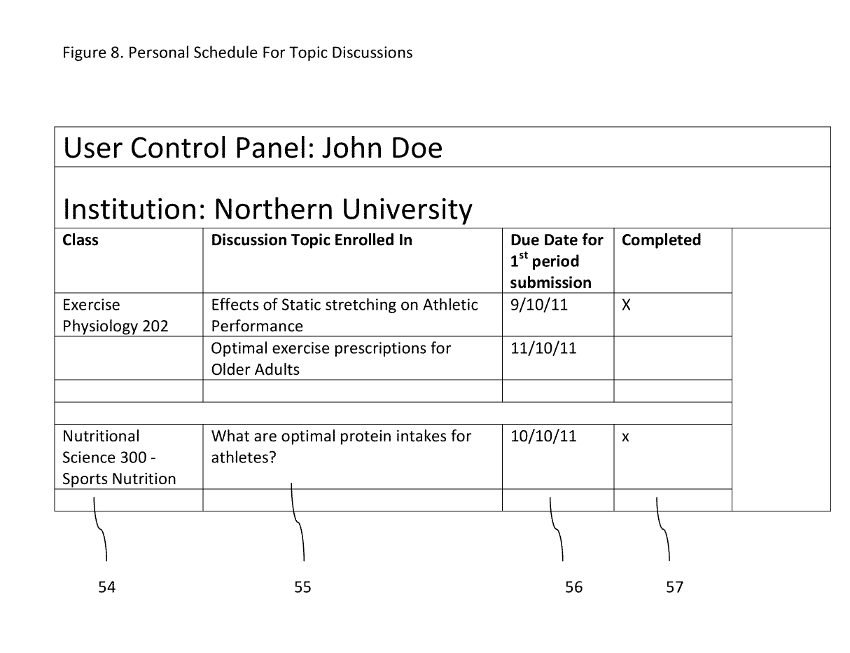

From the user control panel and private message tabs 46, one is also able to access their personal topic discussion schedule (FIG. 8) that they have been enrolled in. Included in this schedule is each one of their classes 54 which is taken part in the program. Also found here are the discussions in which they are enrolled in 55, the due date on round 1 submission 56 and if they have completed their 1^{st} round posting 57. If they have already submitted a response, an “X” or check mark will appear in the appropriate box.

### 4. Multi-Period Posting Process

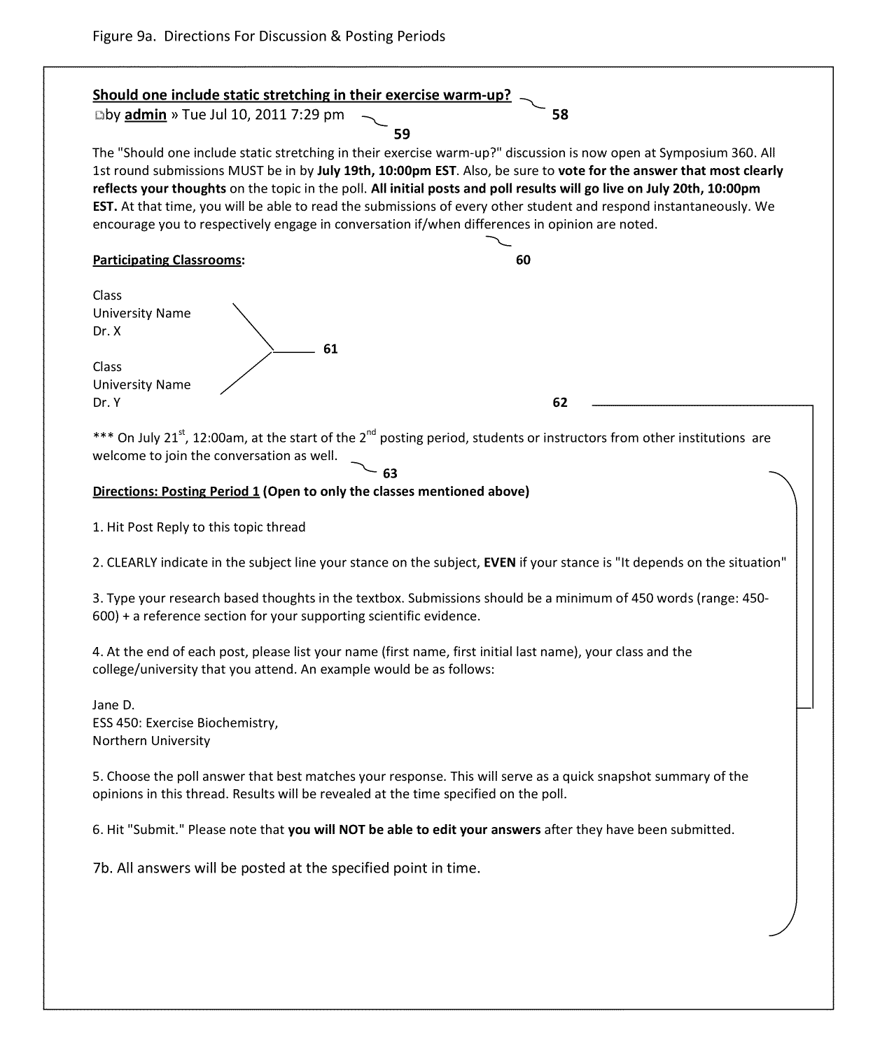

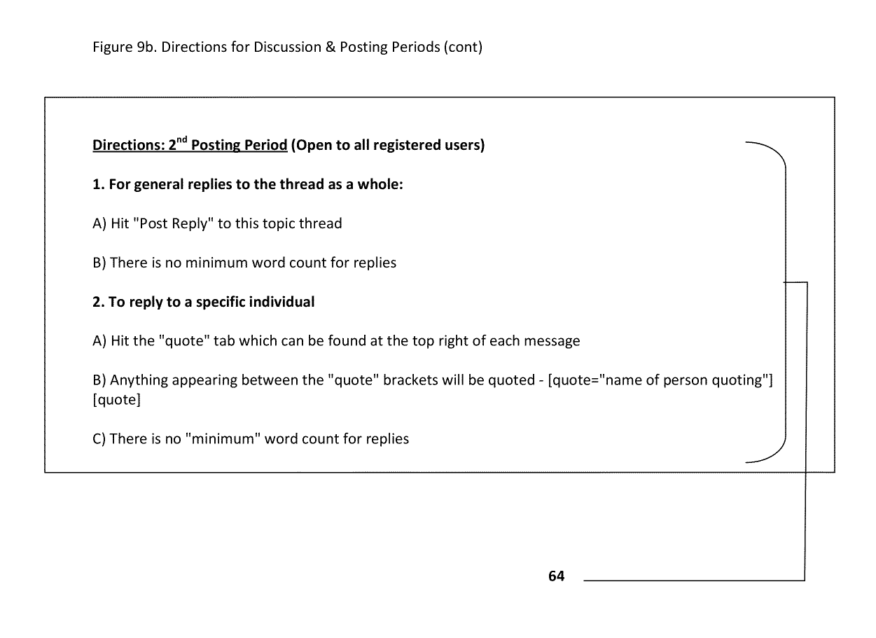

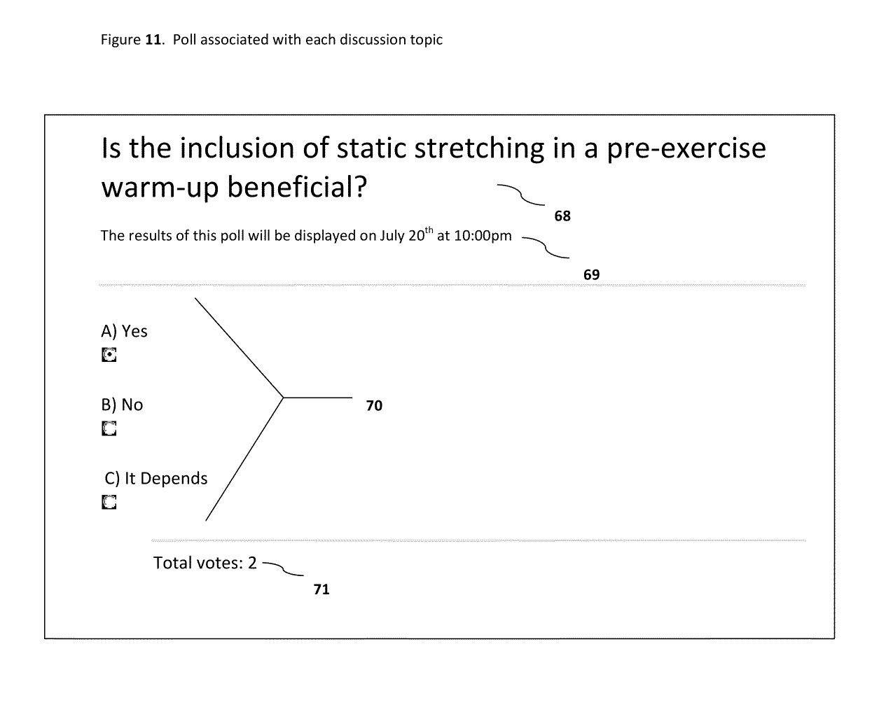

The 1^{st} posting period process will begin in accordance to the date listed for each topic 33, 35, 36 that can be accessed by clicking on the discussion topic schedule tab 48 located within each specific educational forum 45. Once these dates arrive, each Specific Discussion Topic will be posted in the live discussion topics section of each respective forum as shown in FIG. 6. Upon clicking on a given discussion, users and observers will come to FIGS. 9a, 9b which has directions for the posting periods as well as a poll (FIG. 11) that is associated with each topic. FIG. 9a shows an example of how the 1^{st} post of each discussion page may look. It will show the title of the discussion 58, the date at which it went live 59, as well as an introduction into the discussion 60 that discusses the dates at which all 1^{st} round postings must be submitted to the program. Other key features on this page include the instructors, institutions and classes 61 participating in the first posting period and step by step posting directions for both posting periods 62, 64. The directions, including, the word count, use of references, and ability to edit posts, can change from topic to topic depending on the wishes of the instructor users. Finally, the date at which the 2^{nd} posting period begins 63 can be found here. As discussed above, the 1^{st} posting period is open only to those students whose instructors signed them up to participate, whereas the 2^{nd} posting period is available to all registered users for both posting and viewing answers. Alternatively, the first 2-5 days of the 2^{nd} posting period may be restricted to only participating classrooms prior to being opened up to all users.

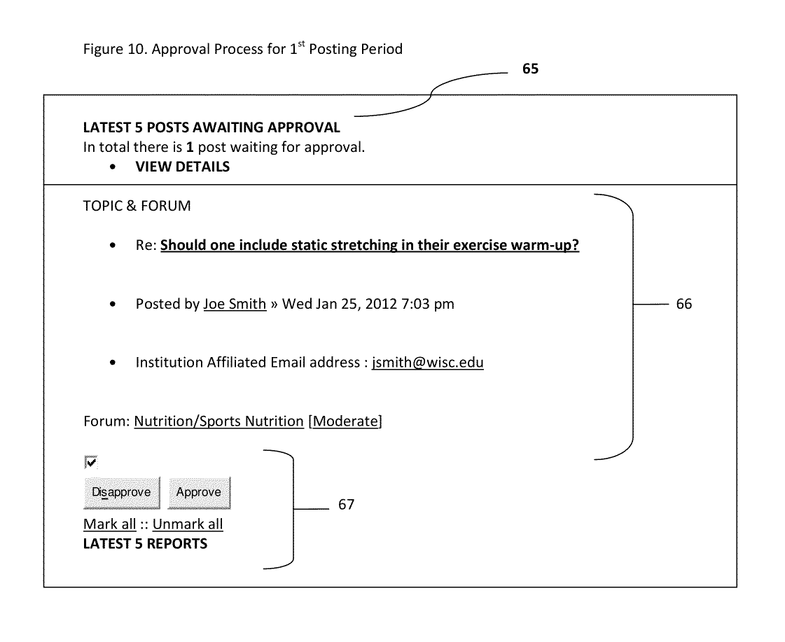

All 1^{st} period postings will be held until the time period specified in 60. This is done so that one student's viewpoints cannot influence the thoughts of another individual who is still preparing their response for the first posting period. In essence, it will require them to think independently on a potentially controversial subject matter. Also, once submitted, the administrator will receive a notification in their moderator/administrator control panel, as shown in FIG. 10. Included in this notification will be the total number of posts awaiting approval 65 as well as information 66 regarding each specific post that is still waiting to be approved. This information includes the topic which the post was placed in, the username of the individual who posted and the institution affiliated email address. Thus, by associating the institution email addresses with that of the participating institutions, one can regulate who posts during this first time period. If the email address matches up with the participating institutions, this post may be approved/disapproved for the first time period by clicking on the appropriate approval/disapproval tab 67. This process may be completed manually or via software specifically designed for the task. If a post does not match up with the participating institutions, the administrator may also “hold” the submitted post and wait till the 2^{nd} posting period before approving it. In another embodiment, the instructor gives a student a course password that will be typed in when submitting their 1^{st} round response, thus eliminating the use of institution email addresses as a means to restrict posting.

Some, but not necessarily all, discussions will have a poll associated with them similar to that which is seen in FIG. 11. As detailed in the directions 62 of the first posting period, users will be asked to vote during the initial posting period when they submit their topic responses. Included on this poll are the question/topic 68 of which the specific discussion topic is based on, the date at which the results will go live 69, voting options 70, and the total number of votes 71. The date at which results from the poll are posted will likely, but not necessarily, be at the same time in which all 1^{st} round responses are posted “live.”

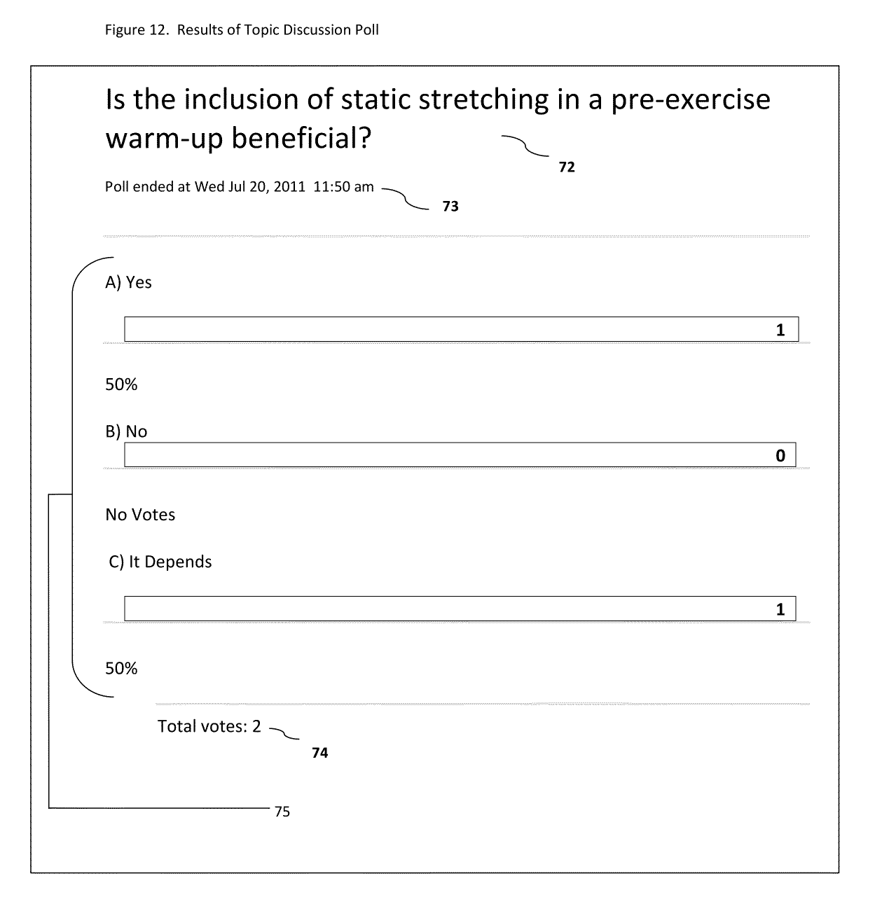

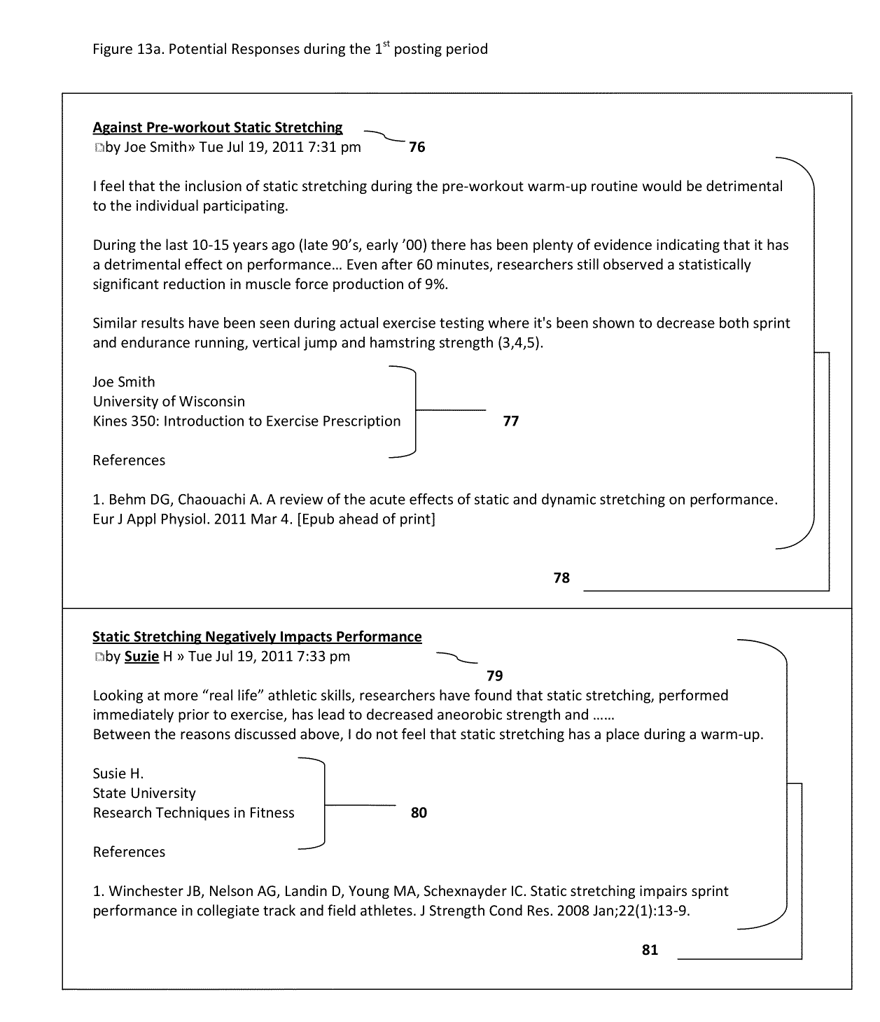

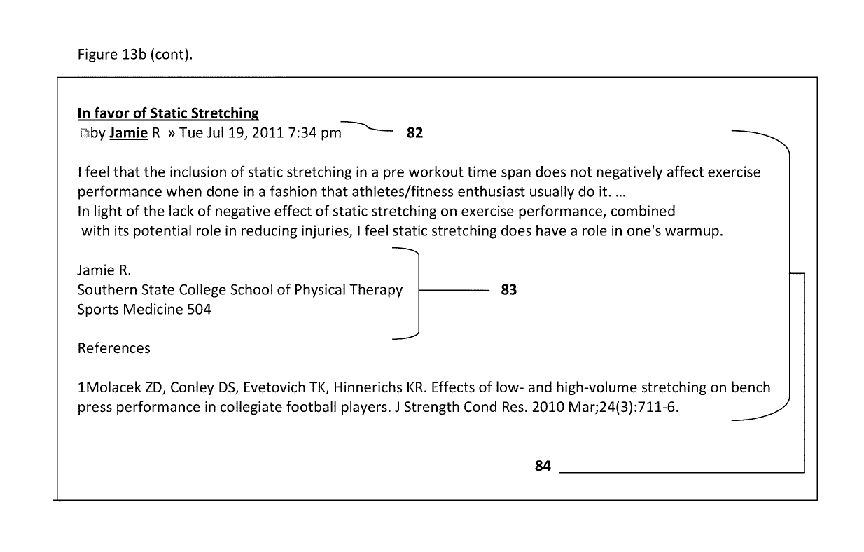

After the deadline of the first time period has passed, the results of the poll will be revealed as seen in FIG. 12. Information that will be displayed includes the title 72, when it ended 73, total number of votes 74 and the results 75. The results may be revealed via bar graphs, pie charts or similar graphical displays. In addition, posts submitted by participating institutions will be made public at this time. An example of how these posts may appear is shown in FIGS. 13a, 13b. Included in the responses will be the title of the individuals post, their name and the date. See items 76, 79, and 82. In an alternative embodiment, information currently found in 77, 80, 83 (name or pseudo name, institution, class-specific educational class if appropriate) may automatically appear in areas 76, 79, and 82 rather than being manually typed in by the user. In the example 1^{st} round posts presented here, the student's response 78, 81, 84 includes both their viewpoints, as well as references used in forming their viewpoints. The use of references in the response is not mandatory. Whether or not references are to be included will be determined by the preferences of the instructor users during the initial sign up period.

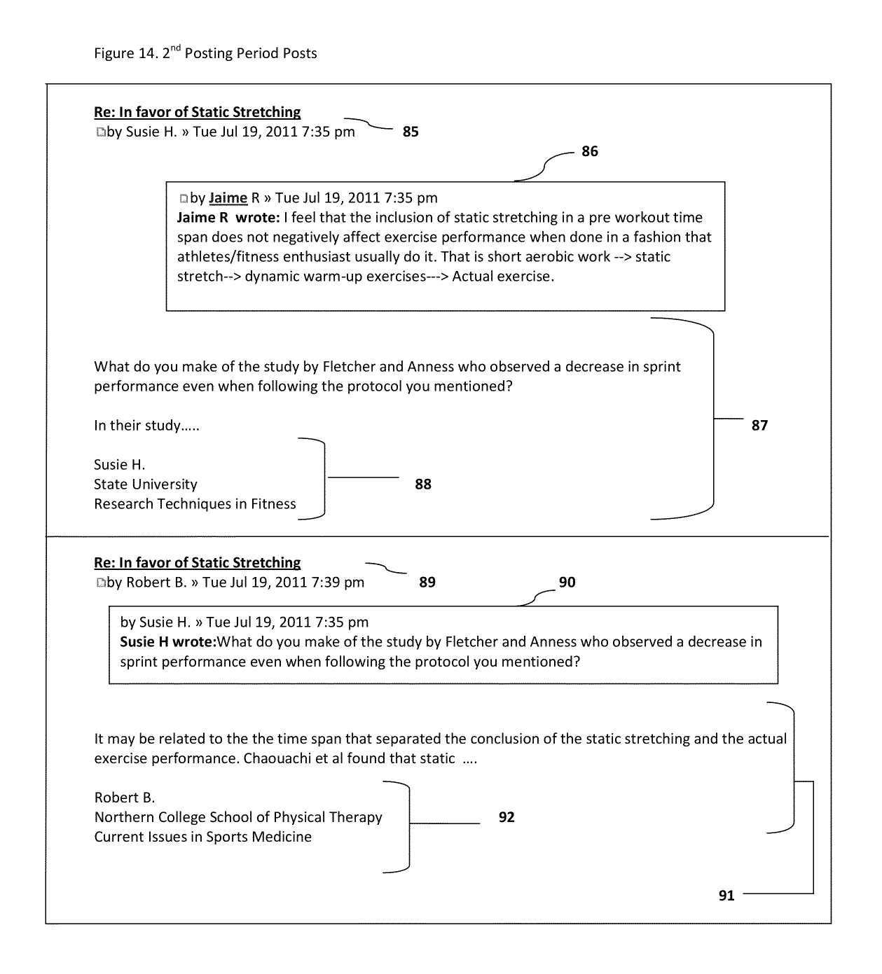

In contrast to the 1^{st} posting period, during the 2^{nd} posting period, there will be no approval/disproval process. The posts will automatically go “live” on the site after students and/or instructors submit their posts. The basic directions 64 for this can be found in FIG. 9b. Due to the immediate appearance of posts, this period will have more of a conversation back and forth feel to it that is common with most forum discussions. Examples of posts during this 2^{nd} posting period can be seen in FIG. 14. Each post will include basic information (name, class, institution, posting date, response) 85, 87 - 89, 91, 92 that is analogous to information 76 -84 present in posts made during the first posting period.

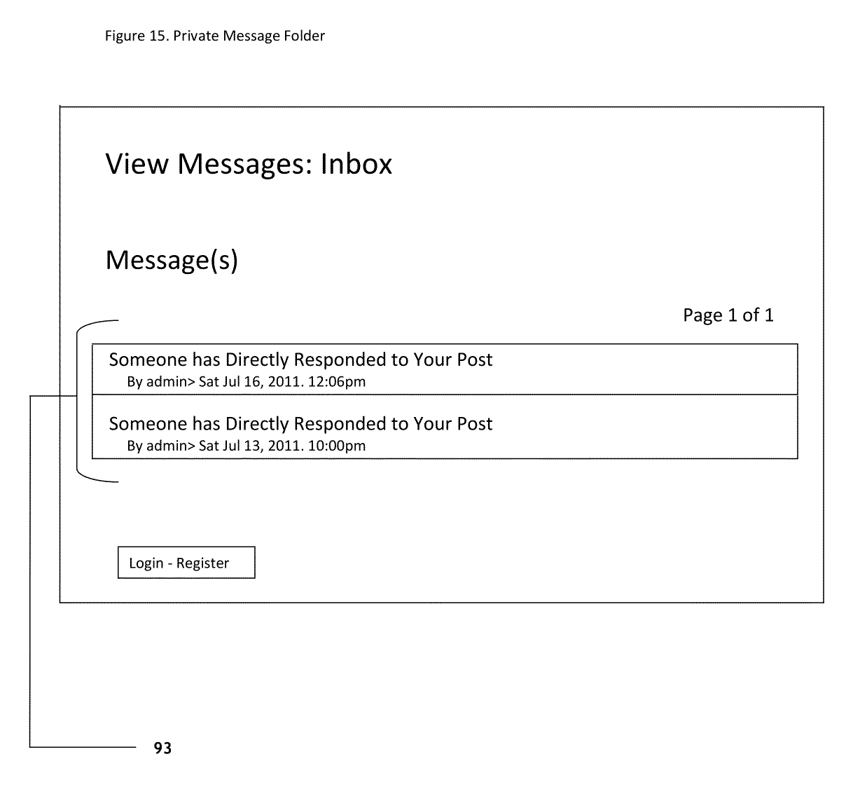

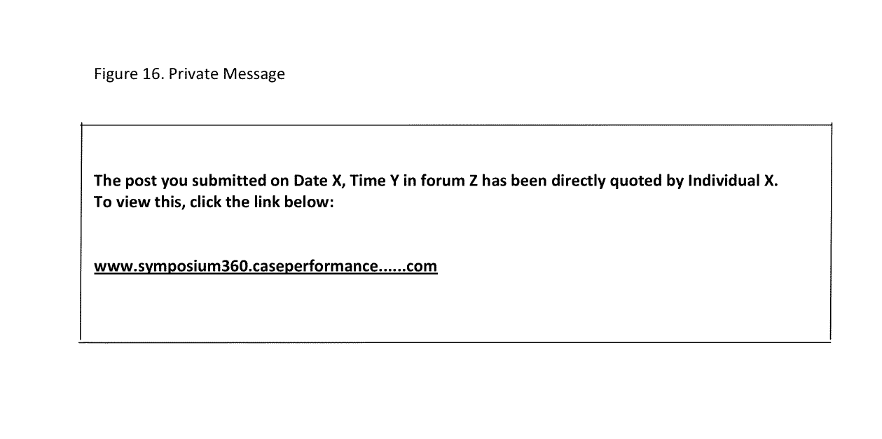

During the 2^{nd} posting period, individuals have the option of using a “direct quote response” which is shown in box 86, 90. Included in this are direct quotes from previous posts that were made earlier. These earlier posts could be from those submitted during the 1^{st} or 2^{nd} posting periods. The use of direct quotes is not mandatory for responses during the 2^{nd} period. If someone's post has been directly quoted or simply referenced, they will be notified via a personal message that can be accessed by clicking on their user control/message panel tab 46 which can be accessed off the site's main page. How this may appear in their message box can be seen in FIG. 15. By clicking on the message 93, it will take you to a message similar to that depicted in FIG. 16.

This process of receiving the quote/reference notification can happen in one of two ways. First, as commonly done with many forums, someone can hit a “quote” or “direct quote” tab when responding to a post, leading to the appearance of direct quote boxes 86,90 on the response post. When this series of events occur, the individual being quoted will receive an email. In essence, clicking on the “quote” or “direct quote” tab, and then submitting the response will trigger the email notification to be sent to the individual who was directly quoted. However, it is common to quote or refer to other people's responses in a reply post by not actually clicking on a quote tab. Additionally, an individual may reference someone's thoughts on a different thread (i.e., “Specific Discussion Topics”), but still be contained within the forum system. In these situations, forums that rely solely upon notifying individuals via mechanisms related to hitting the direct quote button fail to inform an individual that their posting/thoughts have been referenced. Thus, the system may also be set up such that it compares strings of text between old and new posts. If the system deems the posts to be related, the individual who wrote the post being referenced will receive a notification as described above. In this latter format, the system may rely upon the recognition of the username, actual name, related feature unique to poster and/or a string of text contained in the original post that is being referenced. Strings of text would be “X” amount of words that appear in consecutive fashion exactly how it did in the original post and/or a high percentage of the same words in both posts. Since most posts in a Specific Discussion Topic may have a high percentage of the same words, the inclusion of the username, actual name or other unique feature of the individual whose post is being referenced will prevent notifications from being sent to everyone who has submitted posts in that specific discussion topic. In addition, since it will compare new and old posts across the different Specific Discussion Topics throughout the entire forum, it will draw new individuals into a given discussion who may not have had any other reason to check the discussion out, other than the fact that they received a notification that their thoughts had been referenced.

Also, as seen in these 2^{nd} period example posts (FIG. 14), individuals who are responding may be those who posted during the first posting period as well as student or instructor observers 8, 10. For example, 80 and 88 represent the same individual, a student user, who has submitted two responses; one during the 1st posting period and one during the 2^{nd} posting period. Likewise, individuals, such as 92, a student observer, whose instructors decided not to sign their class up for the 1^{st} posting period can also now freely participate in the discussion.

During the posting periods, instructors 2, 3, 7, 9 will be encouraged to share their thoughts. However, this will not be mandatory.

### 5. Termination of 2^{nd} Posting Period & User Accounts

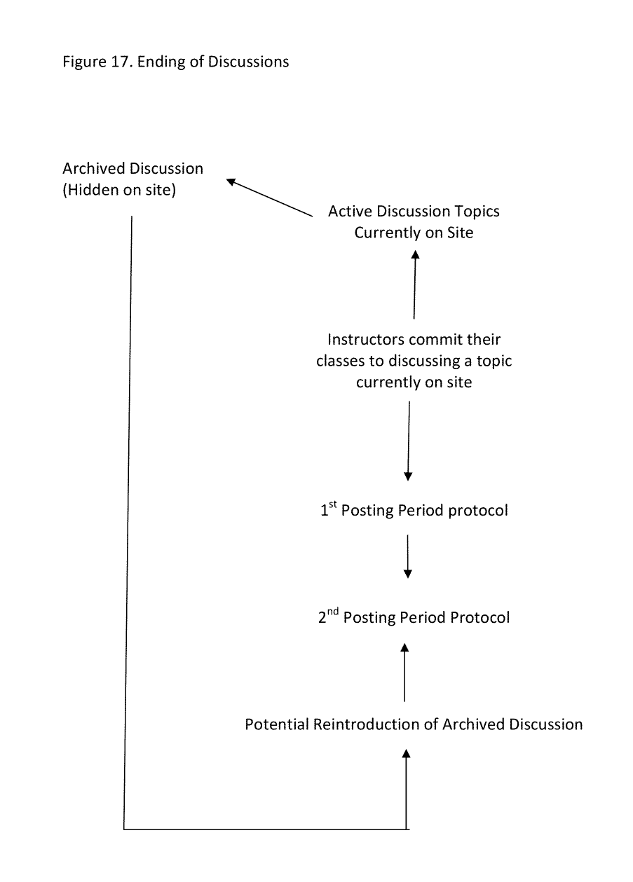

The 2^{nd} posting period may continue for an indefinite amount of time, allowing all future users to participate in the discussion. However, upon repeating steps 12-28, it may be found that a group of instructors would like to have their students discuss the same or similar themed topic to that which has already been posted on the site. For instance, “Protein Requirements for Athletes” may be discussed in year 1. During a following year (or polling period), instructors may be interested in having a new group of students discuss the same topic again. In this situation, as seen in FIG. 17, the original discussion (i.e.,) the one that already appears on the site) will be removed from the site, archived and potentially reintroduced at a later date. While in the archived state, the information would not be viewable on the site. If reintroduced, it would occur at some point during the 2^{nd} posting period.

The other way in which a topic discussion or an individual's post may be deleted is if vulgar or offensive language appears on it. In this situation it will be removed by the site administrator. Likewise, filters can be placed on the program which prevents posts carrying offensive language from appearing in the discussion.

Upon registering with Symposium 360, instructor accounts will remain active for an infinite amount of time. In contrast to instructor accounts, the accounts of students will be cleared out of the system after a predetermined number of years of activity. Once cleared from the system, they will have the same privileges as general observers. Alternatively, former students can still keep posting privileges in the open forum 47, but lose the ability to actively participate in the specific educational forums 45.

Other ideas brought forth herein this document may be recreated or, advanced upon, in future embodiments of this system while still staying within the scope of the intervention. For instance, rather than students and instructors responding to a written topic, they may be exposed to a video clip or webinar and then asked to share their thoughts and opinions on the material presented to them via this form of media. Likewise, they may be asked to read a specific article and give their viewpoint on it using supporting material.

System architecture for implementing the present invention is well-known in the prior art. User interfaces may be browser-based, and an electronic network, such as the Internet, may be used to communicate between users. Examples of system architecture that is suitable for the present invention are disclosed in U.S. Pat. No. 7,908,602 (Alcorn et al.) (see esp. FIGS. 1A-1C); U.S. Patent Application Publication No. 2010/0151431 (Miller) (see esp. FIGS. 1-2); and U.S. Pat. No. 6,347,333 (Eisendrath et al.) (see esp. FIG. 2). Each of these three patent documents is incorporated by reference herein.

The following discussion provides a non-limiting summary of preferred embodiments of the present invention described herein.

1. One preferred embodiment provides a topic selection process illustrated in FIGS. 2a and 2b. Key aspects of the topic selection process include allowing instructors from different universities to suggest topics, pushing the entire list of topics back out to the instructors for selection, and then creating topic forums for the topics that more than one instructor selects.

2. Another preferred embodiment provides for the two different posting periods described above, wherein the 1st posting period is limited to students who are taking the classes of the instructors who signed up for and/or share a common topic of interest, and the 2^{nd} posting period is open to other registered users who were not signed up to participate during the 1^{st} posting period, for purposes of posting answers/comments, and/or is open to the students who made postings in the 1st posting period to comment on their fellow student's postings.

3. Another preferred embodiment provides a posting period (here, the 1^{st} posting period) wherein answers/comments can be posted by students from “different institutions” who are registered for courses that are in a similar general area of academic interest (e.g., e.g., ESS 400: Topics in Sports Medicine at Northern College, and KINES 350: Introduction to Exercise Physiology at Southern College). That is, the courses at the different institutions need not be the same general course or the same level of course, but need only have one or more similar areas of academic interest such that both courses may at some point during the course be interested in the same topic, wherein the respective instructors may select the same topic and thereby end up sharing a topic forum.

4. Another preferred embodiment provides a notification process so that if a discussion participant directly quotes the contents of an originally posted response during the 2^{nd} posting period or references the contents of a previous post, the person who made the original posting is notified of that fact and is provided with contact information regarding the discussion participant. In this manner, users of the system will be able to network with individuals who may have common interests, as evidenced by their interest in quoting the original poster.

Preferred embodiments of the present invention may be used in a virtual classroom environment or in a traditional classroom experience.

The present invention may be implemented with any combination of hardware and software. If implemented as a computer-implemented apparatus, the present invention is implemented using means for performing all of the steps and functions described above.

When implemented in software, the software code can be executed on any suitable processor or collection of processors, whether provided in a single computer or distributed among multiple computers.

The present invention can also be included in an article of manufacture (e.g., one or more computer program products) having, for instance, computer readable storage media. The storage media has computer readable program code stored therein that is encoded with instructions for execution by a processor for providing and facilitating the mechanisms of the present invention. The article of manufacture can be included as part of a computer system or sold separately.

The storage media can be any known media, such as computer memory, one or more floppy discs, compact discs, optical discs, magnetic tapes, flash memories, circuit configurations in Field Programmable Gate Arrays or other semiconductor devices, or other tangible computer storage medium. The storage media can be transportable, such that the program or programs stored thereon can be loaded onto one or more different computers or other processors to implement various aspects of the present invention as discussed above.

The computer(s) used herein may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile, or fixed electronic device.

The computer(s) may have one or more input and output devices. These devices can be used, among other things, to present a user interface. Examples of output devices that can be used to provide a user interface include printers or display screens for visual presentation of output and speakers or other sound generating devices for audible presentation of output.

Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. An automated method of selecting topics of interest for a plurality of classrooms which are teaching different, but semi-related education disciplines, at least some of the classrooms being at a plurality of different educational institutions, the method comprising:
(a) receiving at a processor a first set of potential topics of interest from instructors associated with the plurality of classrooms;
(b) assembling in the processor a master list of each of the potential topics of interest;
(c) electronically communicating the master list to the instructors via the processor;
(d) receiving at the processor a second set of potential topics of interest from the instructors associated with the plurality of classrooms, wherein the second set of potential topics of interest include:
(i) any potential topics of interest that the instructors identified in the master list as a potential topic of interest that the instructor initially sent to the processor in step (a), and
(ii) any potential topics of interest that the instructors identified in the master list that was submitted by a different instructor but which is a potential topic of interest for the respective instructors;
(e) electronically identifying in the processor any potential topics of interest which were identified as being of interest in both steps (d)(i) and (d)(ii), thereby having been identified as being the same potential topic of interest by more than one instructor, and wherein at least two of the instructors for the same potential topic of interest are from different institutions;
(f) creating in the processor a list of selected topics of interest based on the potential topics of interest identified in step (e), the selected list of topics of interest including for each topic, the instructors who selected the same topics in steps (d)(i) or (d)(ii); and
(g) electronically communicating the selected list of topics to the respective instructors for use in their respective classrooms, each instructor receiving only the topics on the selected list that the instructor selected in either steps (d)(i) or (d)(ii).

2. The method of claim 1 wherein an electronic posting site is provided by the processor for posting answers and/or comments from instructors and their respective students to the respective selected topics, the method further comprising:
(h) providing a first posting period for allowing only the instructors and their respective students who are working on the same topics to post answers and/or comments for the respective topics; and
(i) providing a second posting period subsequent to the first posting period for allowing instructors and their respective students who are not working on the same topics to post their answers and/or comments for the respective other topics.
